(19) United States
(12) Patent Application Publication
(10) Pub. No.: US 2008/0289524 A1
(43) Pub. Date: Nov. 27, 2008

(54) Roller Micro-Contact Printer with Pressure Control

(75) Inventor: Michiel J. Jongerius, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,994

(22) PCT Filed: Oct. 19, 2005
(86) PCT No.: PCT/IB2005/053426

§ 371 Date: Dec. 20, 2006

Related U.S. Application Data
(60) Provisional application No. 60/621,200, filed on Oct. 22, 2004.

(51) Int. Cl. B41F 13/10

(52) U.S. Cl. 101/376

(57) ABSTRACT

A micro-contact printing apparatus includes a roller (100, 200, 300) with a gas filled volume (220, 320) that deforms to provide a more uniform and better-controlled surface pressure for a deformable stamp roller surface (240, 340). In one approach, a gas-filled volume (220) is provided in a deformable gas-tight material (225) within a cylindrical support (210). Mechanical supports (230, 234, 241, 246, 251) such as pins couple the stamp roller surface (240) to the deformable gas-tight material (225). Or, the gas filled volume (320) may be provided between a gas-tight cylindrical support (310) and a stamp roller surface (340). Mechanical supports (330, 332) such as folded blades, couple the stamp roller surface (340) to the cylindrical support (310) while preventing lateral movement of the stamp roller surface relative to the cylindrical support. Active control (130) of the pressure in the gas filled volume may also be provided.

The invention relates generally to micro-contact printing, and in particular, to a technique for performing micro-contact printing with pressure control.

Micro contact printing is a technology for printing very fine line patterns, down to about 200 nm. Essentially, it is a “Hochdruck” technology in which a pattern on a rubber stamp is reproduced on a substrate. So far, mainly monolayers of resist are printed; however, the direct printing of other materials/functions is under investigation. A disadvantage of the technology is that the printing should be done with the application of very low pressure (e.g., about 0.1 bar), to ensure that not only the required image is printed, but also in between areas are pressed into contact with the substrate. See, e.g., A. Bietsch and B. Michel, “Conformal contact and pattern stability of stamps used for soft lithography”, J.Appl.Phys., 88(7), 4310-4318 (2000), and C. Y. Hui et al., “Constraints on microcontact printing imposed by stamp deformation”, Langmuir 18 (4), 1394-1407 (2002). Recently, a new version of this technology called wave printing was introduced. See PCT publication WO 03/099463, entitled “Method And Device For Transferring A Pattern From A Stamp To A Substrate”, published Dec. 4, 2003 (docket no. ID 606046/9188). This technology enables the controlled application of such very low pressures. The disadvantage is, however, that this technology is not suitable for continuous flow-line sort of production, such as required in current and future roll-to-roll types of processing.

The present invention addresses the above and other issues. In particular, the current invention is aimed at enabling such continuous processing by modifying the more usual roller type of printing (e.g., as applied in flexographic printing) to the specific requirements of micro-contact printing. In conventional flexographic printing, a roller covered with a rubber stamp is brought into contact with a substrate, which is transported in a linear motion under the roller. The rotation of the roller is synchronized with the linear motion of the substrate to prevent slip. The print pressure on the stamp is achieved by compressing the roller to, the substrate. In this way, however, a strongly non-uniform printing pressure distribution is obtained, in which maximum pressure is present at the central (most compressed) contact area under the roller, while the pressure falls off to a low value at the beginning and final parts of the contact area. This makes it difficult to control and maintain this pressure accurately to a low value. In practice, a so-called “kiss printing” condition is searched for, where a very light pressure is used so that the stamp just contacts the surface. However, this condition is difficult to maintain since it requires a very accurate surface flatness for the substrate and the print roller.

The invention provides a solution to the above-mentioned limitations by providing a roller with a gas filled volume that deforms to provide a more uniform and better-controlled surface pressure for a deformable stamp roller surface.

In one aspect of the invention, a micro-contact printing apparatus includes a cylindrical support, a deformable gas-tight material defining a gas filled volume within the cylindrical support, a deformable stamp roller surface on which a micro-contact stamp is carried, and a plurality of mechanical supports provided between the stamp roller surface and the deformable gas-tight material for transferring deformation forces from the stamp roller surface to the deformable gas-tight material during printing.

In another aspect of the invention, a micro-contact printing apparatus includes a gas-tight cylindrical support, a stamp roller surface on which a micro-contact stamp is carried, a gas filled volume provided between the cylindrical support and the stamp roller surface, and a plurality of resilient mechanical supports provided between the cylindrical support and the stamp roller surface for preventing lateral movement of the stamp roller surface relative to the cylindrical support.

In the drawings:

In all the Figures, corresponding parts are referenced by the same reference numerals.

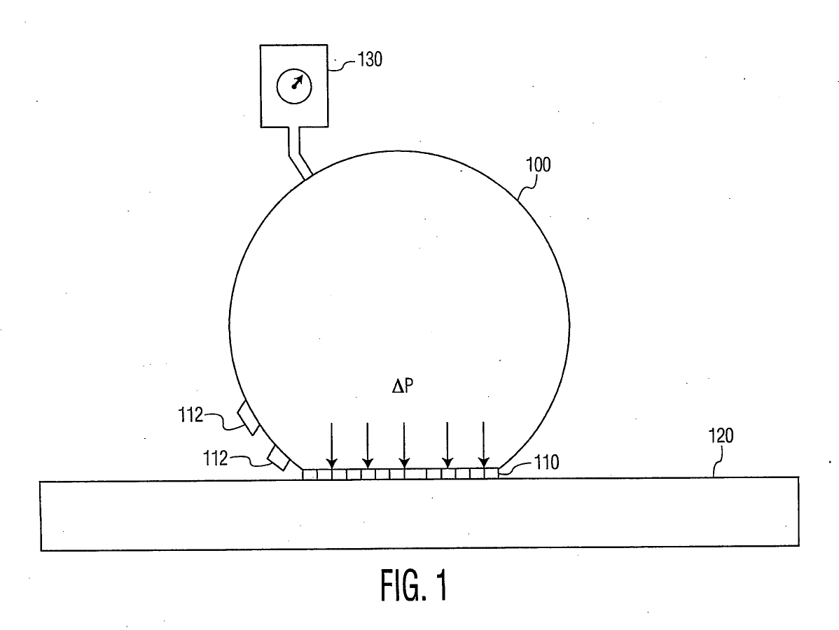

FIG. 1 illustrates a gas filled printing roller with a micro-contact printing stamp, according to the invention;

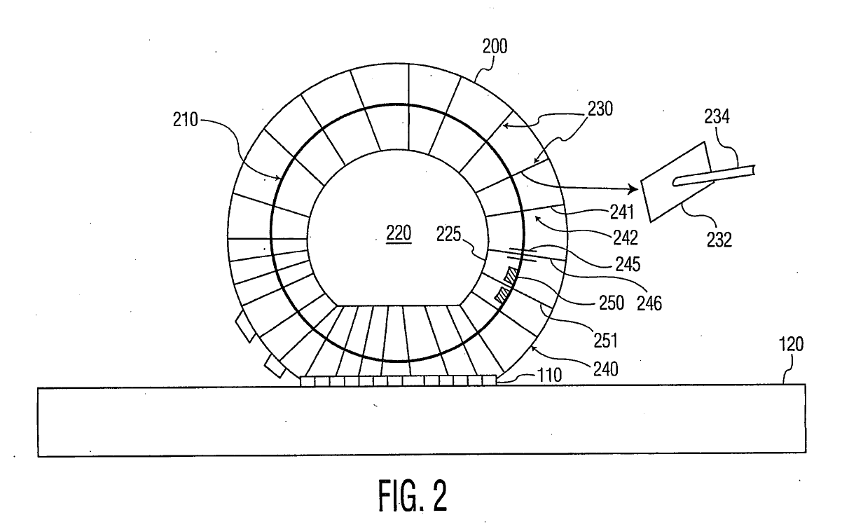

FIG. 2 illustrates a schematic view of a roller construction with a hard cylindrical support and central gas filled volume, according to the invention; and

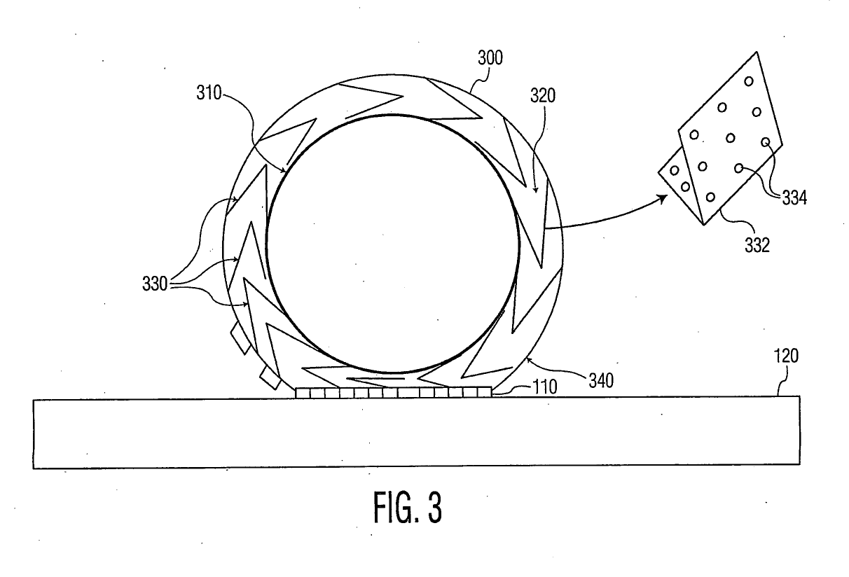

FIG. 3 illustrates a schematic view of a roller construction with a hard cylindrical support and gas filled shell between the cylindrical support and a roller surface, according to the invention.

In one aspect of the invention, a gas filled roller is used to provide a more uniform and better-controlled print pressure. In particular, FIG. 1 shows a gas filled printing roller 100 covered with a micro-contact printing stamp 110 for printing on a surface or substrate 120. The stamp 110 may extend around the roller 100, although only a portion is illustrated for simplicity. The stamp includes a number of individual segments 112. The size of the contact area is not to scale, but is shown much larger than in a practical situation for clarity. The gas-filled roller 100, which can be analogized to a bicycle tire, is brought in contact with the surface to be printed 120. As a result, a relative printing pressure ΔP is obtained which is approximately uniform over the contact area. This specific benefit is essentially the result of the introduction of a large air chamber—a new concept in the printing field. In particular, the shape of the gas filled volume deforms to even out the pressure across the contact area of the stamp 110 when the stamp contacts the surface 120 to be printed on.

The value of the print pressure is given by the net pressure in the roller (relative to the environmental pressure), which can be adjusted to obtain the low printing pressure required. In addition, this pressure can be actively controlled and kept adjusted at the required print pressure value. A major benefit of this approach is that the printing pressure value is set in this way independently from the size of the contact surface 120 and from the corresponding vertical position of the roller with respect to the surface.

In particular, experimental work shows that, dependent on the shape and on/off ratio of the patterns in the stamp, a collapse of the stamp may occur for net pressures of the stamp on the surface of down to about 0.1 bar. This was for a flat stamp on a flat surface. The required pressure in the roller version is therefore up to an order of about 0.1 bar higher than ambient. Regarding the active control, if the roller contains a sealed volume, then the pressure increases if the roller is pressed on the surface to be printed. As a result, the (local) pressure value of the stamp on the surface also increases. The volume can, however, be connected to a pressure sensor and a pump 130 so that the pressure in the volume can be maintained at a set value. Specifically, the pressure sensor and pump 130 bleed gas out of the volume 100 when it is compressed during printing to avoid an increase in pressure. The gas can be air or other suitable gas. Moreover, note that a fluid filled volume may be used in place of gas if the fluid pressure is kept constant, e.g., by a tube connection to separate external pressure control unit.

When printing is completed and the roller 100 no longer contacts the substrate 120, gas is pumped into the volume to maintain the desired pressure. The pressure can also be adjusted for different printing pressures. Moreover, ambient pressure changes can also be corrected for by adding gas when the ambient pressure increases. Implementation of the pressure sensor and pump 130 can be achieved using various technologies known to those skilled in the art.

In contrast to the example of a tire, the air pressure in the roller 100 need not be set at a high value, since it need not support the weight of the roller 100. This weight can be supported by an axle along the roller's rotation axis, for instance. For example, as discussed further below in connection with FIGS. 2 and 3, a hard cylindrical support can be supported by an axle along a rotation axis. This axle supports the weight of the whole roller, since otherwise this weight can easily lead to a large total contact area between the stamp and the surface. In contrast, a bicycle tire at a given air pressure has more contact area with the road for a heavy car than for a light car.

The invention achieves several benefits, including: (1) The printing pressure is uniform over the contact area between the roller and substrate; (2) The vertical position of the roller is less critical, such as in the above-described kiss-printing situation; and (3) If stretching of the stamp surface is prevented, the distortion in the printed image can be kept to a minimum.

However, in practice, the above scenario cannot be realized without additional measures. A mechanical contact is required between the stamp surface and the roller axle, for instance. Various approaches may be used to achieve this. One possible approach is schematically illustrated in FIG. 2, which provides a schematic of a roller 200 with a micro-contact stamp surface 240, a hard, non-deformable cylindrical support 210 and a central gas filled volume or container 220. The contact area is not shown to scale. The cylindrical support 210 need not be precisely a cylinder but may be comprised of a number of flat surfaces, for example. The volume 220 may be formed by a deformable, gas-tight material 225 such as rubber that acts as a bladder. The volume 220 may be donut shaped to accommodate a central axle.

Mechanical supports 230 such as connecting pins connect the volume 220 with the contact stamp surface 240 and the micro-contact stamp 110. The mechanical supports 230 are spaced apart circumferentially between the cylindrical support 210 and the deformable gas-tight material 225. The mechanical supports 230 are free to move radially, perpendicular to the cylindrical surface 240, but not laterally, so that lateral slip is prevented. A mechanical contact is provided between the connector pins 230 and the inside surface of the stamp 110 so that deformation forces that occur at the contact stamp surface 240 during printing are transferred to the gas-tight material 225 and the volume 220. There are various joining possibilities, for example, including simply gluing them together, or providing a cone shaped pin into a cone shape hole in the backside of the stamp.

One end of each pin may be secured to the contact stamp surface 240, while the other end may have a flat surface that contacts the deformable material 225 to transmit deformation forces from the contact stamp surface 240 to the gas-tight material 225 and the gas filled deformable volume 220. An example mechanical support 234 is connected at its radially inward end to a generally planar surface 232 to exert a force on the deformable material 225. The radially outward end is connected to, or contacts, the contact stamp surface 240. A generally planar surface can be provided at the radially outward end as well.

Furthermore, the mechanical supports 230 may be contained within apertures in the cylindrical support 210. Various approaches may be used. For example, the cylindrical support 210 may be relatively thin compared to the length of the mechanical supports 230, as indicated by example aperture 242 such as a through hole through which support 241 is provided. Or, an example guiding structure 245, such as a tube, may be provided to better guide the movement of the support 246 so that only a radial movement is allowed. Or, the cylindrical support 210 may be relatively thick compared to the length of the mechanical supports 230, as indicated by example cylindrical support wall 250. In this case, an aperture such as a through hole in the support wall 250 is thick enough to guide the movement of the mechanical support 251 so that only radial movement is allowed. Various other approaches will be apparent to those skilled in the art. Moreover, multiple mechanical supports may be provided along the length of the roller 200, parallel to its axis of rotation.

When the contact stamp surface 240 is deformed during printing process due to contact with the substrate 120, a corresponding deformation is produced in the deformable material 225 by a radially inward movement of the pins 230 in the vicinity of the contact region. This deformation is indicated by the flat, bottom region of the material 225 in FIG. 2. In particular, gas in the gas filled volume 220 compresses when the deformation forces from the stamp roller surface 240 are transferred to the deformable gas-tight material 225 during printing. This compression evens out a pressure across a contact area of the micro-contact stamp 110 during printing. The cylindrical support 210 does not flex, because that would lead to deformation forces and image distortions. In contrast to the situation in FIG. 3, in FIG. 2 the gas is assumed to be only present in the central gas filled volume 220. As an alternative to the embodiment of FIG. 2, however, one might also fill the whole volume inside the roller 200 with gas. Additional holes in the cylindrical support 210 can be provided to allow passage of the gas.

Another possible approach is illustrated in FIG. 3. FIG. 3 provides a schematic of a roller construction 300 with a hard, gas-tight cylindrical support 310 and gas containing shell or volume 320 between the cylindrical support 310 and the micro-contact stamp 110. Again, the contact area is not to scale. A connecting “blade” construction, with folded mechanical supports 330 such as blades, prevents lateral motion of the micro-contact stamp 110 and the stamp surface 340 relative to the cylinder 310. The mechanical supports 330 are spaced apart circumferentially between the cylindrical support 310 and the stamp roller surface 340. The supports 330 may be perforated to allow the gas to flow freely. An example support 332 with perforations 334 may be provided. The perforations are not required as long as the gas is in one way or another free to flow in the whole area between the hard cylinder 310 and the stamp roller surface 340. Providing a few holes in the supports 330, or configuring the supports so that they do not extend completely along the full axis direction, e.g., by placing the supports in staggered positions, might leave sufficient open channels to allow for this free flow of air. On the other hand, porosity in the supports 330 must not be so large that the supports 330 are no longer sufficiently stiff along the blade direction. That would lead to slip in the lateral direction.

The mechanical supports 330 prevent the lateral slip of the stamp surface 340 and the stamp 110 with respect to the hard, non-deformable cylindrical support 310. They do, however, allow for the indentation, which is small, in practice, of the stamp surface 340 by the contact with the substrate 120. The blades 330 can be made from thin sheets of folded metal, for example, that demonstrate minimum resilience when folded so that the air pressure on the stamp can bring them back toward their original position after being deformed or compressed. In practice, gas in the gas filled volume 320 compresses when the stamp roller surface 340 deforms during printing. This compression evens out a pressure across a contact area of the micro-contact stamp 110 during printing.

It will be apparent to those of ordinary skill in the art that various other mechanical support constructions can be used to satisfy the goal of minimizing lateral shifts of the stamp surface, while still allowing for the almost free vertical motion of the stamp surface 340.

Applications of this invention include printing on large-area fine line patterning areas, such as displays (active and passive plates) and in (polymer) electronics, among others.

Accordingly, it can be seen that the present invention provides a micro-contact stamp printer that provides a uniform, low printing pressure in the contact area, along with a minimum lateral displacement of the print surface to avoid distortion. The invention also avoids lateral slip in the printed image. Moreover, a flexible coupling between the stamp and a cylindrical support allows for a vertical motion to allow the stamp to locally follow the surface to be printed on.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A micro-contact printing apparatus, comprising:
a cylindrical support (210);
a deformable gas-tight material (225) defining a gas filled volume (220) within the cylindrical support;
a deformable stamp roller surface (240) on which a micro-contact stamp (110) is carried; and
a plurality of mechanical supports (230, 234, 241, 246, 251) provided between the stamp roller surface and the deformable gas-tight material for transferring deformation forces from the stamp roller surface to the deformable gas-tight material during printing.

2. The micro-contact printing apparatus of claim 1, wherein:
the cylindrical support is non-deformable.

3. The micro-contact printing apparatus of claim 1, wherein:
the plurality of mechanical supports are spaced apart circumferentially between the cylindrical support and the deformable gas-tight material.

4. The micro-contact printing apparatus of claim 1, wherein:
the plurality of the mechanical supports comprise radially movable pins.

5. The micro-contact printing apparatus of claim 1, wherein:
the cylindrical support includes apertures (242) through which the plurality of mechanical supports pass.

6. The micro-contact printing apparatus of claim 1, further comprising:
means (130) for actively controlling a pressure in the gas filled volume.

7. The micro-contact printing apparatus of claim 1, wherein:
gas in the gas filled volume compresses when the deformation forces from the stamp roller surface are transferred to the deformable gas-tight material during printing.

8. The micro-contact printing apparatus of claim 7, wherein:
the compression of the gas in the gas filled volume evens out a pressure across a contact area of the micro-contact stamp during printing.

9. A micro-contact printing apparatus, comprising:
a gas-tight cylindrical support (310);
a stamp roller surface (340) on which a micro-contact stamp (110) is carried;
a gas filled volume (320) provided between the cylindrical support and the stamp roller surface; and
a plurality of mechanical supports (330, 332) provided between the cylindrical support and the stamp roller surface for preventing lateral movement of the stamp roller surface relative to the cylindrical support.

10. The micro-contact printing apparatus of claim 9, wherein:
the cylindrical support is non-deformable.

11. The micro-contact printing apparatus of claim 9, wherein:
the plurality of mechanical supports are spaced apart circumferentially between the cylindrical support and the stamp roller surface.

12. The micro-contact printing apparatus of claim 9, wherein:
the plurality of mechanical supports comprise folded blades.

13. The micro-contact printing apparatus of claim 9, wherein:
the plurality of mechanical supports include perforations (334).

14. The micro-contact printing apparatus of claim 9, further comprising:
means (130) for actively controlling a pressure in the gas filled volume.

15. The micro-contact printing apparatus of claim 9, wherein:
gas in the gas filled volume compresses when the stamp roller surface deforms during printing.

16. The micro-contact printing apparatus of claim 15, wherein:
the compression of the gas in the gas filled volume evens out a pressure across a contact area of the micro-contact stamp during printing.
